(19) United States
(12) Patent Application Publication
(10) Pub. No.: US 2014/0077999 A1
(43) Pub. Date: Mar. 20, 2014

(54) METHOD AND APPARATUS FOR DETECTING LOCATIONS OF MULTIPLE RADIO SOURCES

(71) Applicant: Electronics and Telecommunications Research Institute, (US)

(72) Inventors: Seong Kyun JEONG, Suwon-si (KR); Sang Uk LEE, Daejeon (KR)

(73) Assignee: Electronics and Telecommunications Research Institute, Daejeon (KR)

(21) Appl. No.: 13/846,554

(22) Filed: Mar. 18, 2013

(30) Foreign Application Priority Data
Sep. 18, 2012 (KR) 10-2012-0103128

(51) Int. Cl. G01S 5/04

(52) U.S. Cl. CPC G01S 5/04
USPC 342/463

(57) ABSTRACT

There are provided a method and apparatus for detecting the transmission locations of radio waves transmitted from multiple radio resources. The method of detecting the transmission locations of radio waves includes: calculating a plurality of direction angles indicating directions of a plurality of radio sources based on a plurality of measuring locations, and detecting a plurality of intersections of lines extending in directions made by the direction angles from the plurality of measuring locations; and selecting real locations of the radio sources from among the intersections using signal intensities of radio waves transmitted from the plurality of radio sources and wave attenuation based on distances from the plurality of measuring locations to the intersections

### CLAIM FOR PRIORITY

This application claims priority to Korean Patent Application No. 10-2012-0103128 filed on Sep. 18, 2012 in the Korean Intellectual Property Office (KIPO), the entire contents of which are hereby incorporated by reference.

### BACKGROUND

1. Technical Field

An example embodiment of the present invention relates in general to a technology of detecting the location of a radio source, and more specifically, to a method and apparatus for detecting the locations of multiple radio sources.

2. Related Art

A technology of detecting the transmission location of a radio wave is used to detect the locations and movements of various radio sources, e.g., vehicles, ships, etc. Recently, with the popularization of various mobile terminals according to the development of mobile communication technologies, demands for a technology of detecting the location of a radio source are increasing.

In general, in order to detect the transmission location of a radio wave, information about the direction of and the distance to a radio source is needed. A technology of detecting the transmission location of a radio wave using the direction angle of a radio source includes recognizing directions in which a radio wave has been transmitted at two or more locations, and detecting the intersection of the directions as the transmission location of the radio wave.

However, when there are two or more radio sources, a plurality of intersections may be made according to the direction angles of the radio sources, and accordingly, it is difficult to specify the transmission location of a radio wave.

In this case, one from among intersections detected by the direction angles of two or more radio sources can be selected based on the results of analysis of the frequency characteristics of radio waves. However, the analysis of the frequency characteristics of radio waves requires a large amount of computing, and furthermore, if the frequency characteristics of the radio waves are similar to each other, it is difficult to accurately specify the transmission locations of the radio waves.

### SUMMARY

Accordingly, example embodiments of the present invention are provided to substantially obviate one or more problems due to limitations and disadvantages of the related art.

An example embodiment of the present invention provides a method of detecting the transmission locations of radio waves transmitted from multiple radio sources.

An example embodiment of the present invention also provides an apparatus for detecting the transmission locations of radio waves transmitted from multiple radio sources.

In an example embodiment, there is provided a method of detecting the location of a radio source, including: calculating a plurality of direction angles indicating directions of a plurality of radio sources based on a plurality of measuring locations, and detecting a plurality of intersections of lines extending in directions made by the direction angles from the plurality of measuring locations; and selecting real locations of the radio sources from among the intersections using signal intensities of radio waves transmitted from the plurality of radio sources and wave attenuation based on distances from the plurality of measuring locations to the intersections.

The selecting of the real locations of the radio sources may include: measuring the signal intensities of the radio waves transmitted from the plurality of radio sources at the plurality of measuring locations; measuring the distances between the plurality of measuring locations and the intersections, and reflecting the wave attenuation based on the distances in the signal intensities of the radio waves, to thereby calculate estimated signal intensities of the radio waves; and selecting the real locations of the radio sources from among the intersections, based on the estimated signal intensities of the radio waves.

The calculating of the estimated signal intensities of the radio waves may include calculating an estimated signal intensity of a radio wave for each intersection at each measuring location.

The selecting of the real locations of the radio sources may include determining intersections for which the estimated signal intensities of the radio waves, estimated at the plurality of measuring locations, are identical to each other as the real locations of the radio sources.

In another example embodiment, there is provided an apparatus for detecting the location of a radio source, including: an intersection detecting unit configured to calculate a plurality of direction angles indicating the directions of a plurality of radio sources based on a plurality of measuring locations, and to detect a plurality of intersections using the plurality of direction angles; a wave intensity measuring unit configured to measure signal intensities of radio waves transmitted from the plurality of radio sources at the plurality of measuring locations; and a radio source location determining unit configured to measure distances between the plurality of measuring locations and the intersections, and to select real locations of the radio sources from among the intersections, using estimated signal intensities of the radio waves obtained by reflecting wave attenuation based on the distances in the signal intensities of the radio waves.

Accordingly, according to the method and apparatus for detecting the locations of radio sources, when radio waves are transmitted from two or more radio sources, the locations of the radio sources can be accurately detected using direction angles and the signal intensities of radio waves, without having to use frequency analysis or other additional information.

Particularly, the transmission locations of radio waves can be quickly detected even when there are interfering sources or jamming occurs.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view for explaining a method of detecting the locations of radio sources, according to an embodiment of the present invention;

FIG. 2 is a flowchart illustrating the method of detecting the locations of the radio sources, according to the embodiment of the present invention; and

FIG. 3 is a block diagram illustrating an apparatus for detecting the locations of radio sources, according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings.

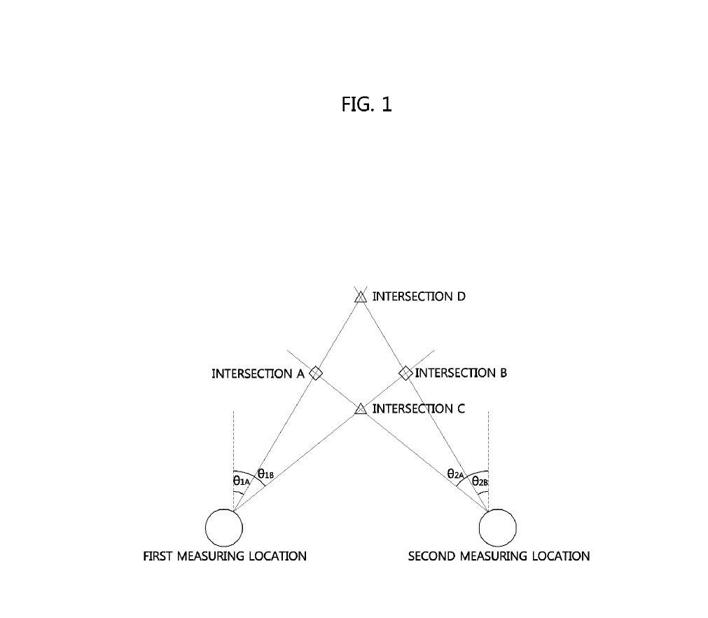

FIG. 1 is a conceptual view for explaining a method of detecting the location of a radio source, according to an embodiment of the present invention.

Referring to FIG. 1, according to the method of detecting the location of the radio source, the locations of a plurality of radio sources may be detected by receiving radio waves at a plurality of measuring locations.

Generally, the location of a radio source may be detected by measuring the direction angles of a radio wave at a plurality of measuring locations. That is, direction angles indicating directions to a radio source are measured based on a plurality of measuring locations, and an intersection of lines extending in the directions made by the direction angles from the measuring locations is detected as the location of the radio source.

However, when the method is used to detect the locations of a plurality of radio sources, a plurality of intersections are made. However, only some of the intersections will be the real locations of the radio sources.

According to the method of detecting the location of the radio source according to the current embodiment, intersections indicating the real locations of a plurality of radio sources can be effectively selected from among intersections detected using direction angles indicating the directions of the radio sources.

In FIG. 1, it is assumed that radio waves are transmitted from two radio sources, and intersections A and B are the real locations of the radio sources.

Radio waves transmitted from the radio sources located at the intersections A and B may be received at first and second measuring locations. Antennas, source location detection apparatuses, etc. may be installed at the first and second measuring locations. The first and second measuring locations may be different locations.

A direction angle indicating the direction of the radio source located at the intersection A with respect to the first measuring location is referred to as θ_{1A}, and a direction angle indicating the direction of the radio source located at the intersection B with respect to the first measuring location is referred to as θ_{1B}.

Also, a direction angle indicating the direction of the radio source located at the intersection A with respect to the second measuring location is referred to as θ_{2A}, and a direction angle indicating the direction of the radio source located at the intersection B with respect to the second measuring location is referred to as θ_{2B}.

Lines extend in the directions of the direction angles θ_{1A} and θ_{1B} from the first measuring location, and lines extend in the directions of the direction angles θ_{2A} and θ_{2B} from the second measuring location.

In this case, the lines extending from the first and second measuring locations intersect with each other to make four intersections A, B, C, and D.

In order to detect the real locations of the radio sources, two of the four intersections A, B, C, and D should be selected.

According to the method of detecting the locations of the radio sources according to the current embodiment, the real locations of radio sources may be detected by using wave attenuation according to distance.

The signal intensities of radio waves transmitted from the radio sources located at the intersections A and B may be measured at the first and second measuring locations, and the measured signal intensities of the radio waves may be used to detect the locations of the radio sources.

The distances between the first measuring location and the intersections A, B, C, and D may be referred to as L_{1A}, L_{1B}, L_{1C}, and L_{1D}, respectively. Also, the distances between the second measuring location and the intersections A, B, C, and D may be referred to as L_{2A}, L_{2B}, L_{2C}, and L_{2D}, respectively.

For example, at the first measuring location, the signal intensities of radio waves received in the directions of θ_{1A} and θ_{1B} may be measured, and wave attenuation according to the distances L_{1A}, L_{1B}, L_{1C}, and L_{1D} may be reflected in the signal intensities of the radio waves measured at the first measuring location, thereby calculating an estimated signal intensity of a radio wave for each intersection.

Also, at the second measuring location, the signal intensities of radio waves received in the directions of θ_{2A} and θ_{2B} may be measured, and wave attenuation according to the distances L_{2A}, L_{2B}, L_{2C}, and L_{2D} may be reflected in the signal intensities of the radio waves measured at the second measuring location, thereby calculating an estimated signal intensity of a radio wave for each intersection.

Accordingly, estimated signal intensities of radio waves at each measuring location may be calculated by reflecting wave attenuation based on the distances between measuring locations and intersections in the signal intensities of the radio waves, and the real locations of radio sources may be detected by determining whether the estimated signal intensities of a radio wave for the same intersection at the measuring locations are identical to each other. For example, the intersections A and B may be selected as the real locations of the radio sources.

FIG. 1 shows the case in which the locations of two radio sources are detected at two measuring locations, however, it is also possible to detect two or more radio sources at two or more measuring locations.

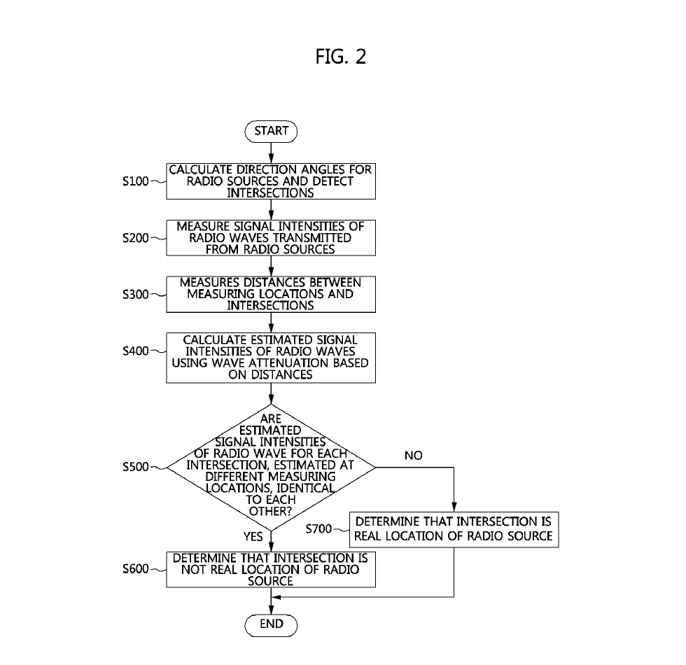

FIG. 2 is a flowchart illustrating the method of detecting the locations of the radio sources according to the embodiment of the present invention.

Referring to FIGS. 1 and 2, the method of detecting the locations of the radio source according to the embodiment of the present invention may include measuring direction angles indicating the directions of a plurality of radio sources based on a plurality of measuring locations, and detecting intersections. Also, the method may include detecting the real locations of the radio sources from among the intersections by using the signal intensities of radio waves transmitted from the radio sources and wave attenuation based on the distances from the measuring locations to the intersections.

First, the direction angles indicating the directions of the radio sources are measured at the measuring locations. That is, antennas, source location detection apparatuses, etc. may be installed at the measuring locations to measure the direction angles indicating the directions of the radio sources based on the measuring locations, and to detect intersections of lines extending in the directions made by the direction angles from the measuring locations (S100). Here, the intersections may be candidate locations of the radio sources.

For example, lines may extend in the directions made by the direction angles θ_{1A} and θ_{1B} from the first measuring location, lines may extend in the directions made by the direction angles θ_{2A} and θ_{2A} from the second measuring location, and intersections A, B, C, and D of the lines may be candidate locations of the radio sources.

Also, signals transmitted from the radio sources are received at the measuring locations, and the signal intensities of radio waves may be measured (S200). That is, the signal intensity of a radio wave corresponding to each direction angle may be measured. Accordingly, the signal intensity of the radio wave may represent the signal intensity of a radio wave transmitted from one of the intersections of the lines extending in the directions made by the direction angles from the measuring locations.

For example, at the first measuring location, the signal intensities of radio waves transmitted in the directions made by the direction angles θ_{1A} and θ_{1B} may be measured, and at the second measuring location, the signal intensities of radio waves transmitted in the directions made by the direction angles θ_{2A} and θ_{2B} may be measured. However, it is impossible to detect the real locations of radio sources only by measuring the signal intensities of radio waves at individual measuring locations.

That is, the real locations of radio sources may be detected by using wave attenuation based on the distances from the measuring locations to the intersections. Accordingly, the distances between the measuring locations and the intersections are measured (S300).

For example, wave attenuation based on the distances L_{1A}, L_{1B}, L_{1C}, and L_{1D} is reflected in the signal intensities of radio waves measured at the first measuring location to calculate an estimated signal intensity of a radio wave for each intersection, and wave attenuation based on the distances L_{2A}, L_{2B}, L_{2C}, and L_{2D} is reflected in the signal intensities of radio waves measured at the second measuring location to calculate an estimated signal intensity of a radio wave for each intersection, in order to detect the real locations of the radio sources.

Also, an estimated signal intensity of a radio wave for each intersection may be calculated for each measuring location (S400), and the real locations of the radio sources may be detected by determining whether or not the estimated signal intensities of a radio wave for the same intersection at the measuring locations are identical to each other (S500).

For example, by estimating the signal intensities of a radio wave for the same intersection at different measuring locations and comparing the estimated signal intensities to each other, the real locations of radio sources can be detected. That is, if the estimated signal intensities of a radio wave for the same intersection, estimated at different measuring locations, are identical to each other, it is determined that the corresponding intersection is the real location of a radio source (S600). On the other hand, if the estimated signal intensities of a radio wave for the same intersection, estimated at different measuring locations, are not identical to each other, it is determined that the corresponding intersection is not the real location of a radio source (S700). Accordingly, the intersections A and B of the intersections A, B, C, and D may be detected as the real locations of the radio sources. Here, by increasing the number of measuring locations, the real locations of radio sources may be more accurately detected.

Accordingly, according to the current embodiment, when radio waves are transmitted from two or more radio sources, the locations of the radio sources can be accurately detected using direction angles and the signal intensities of radio waves, without having to use frequency analysis or other additional information. Particularly, the transmission locations of radio waves can be quickly detected even when there are interfering sources or jamming occurs.

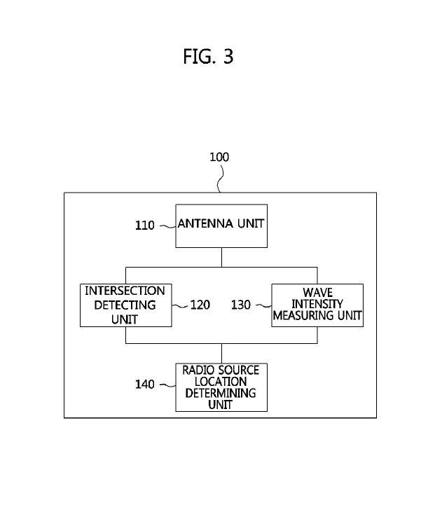

FIG. 3 is a block diagram illustrating an apparatus for detecting the locations of radio sources, according to an embodiment of the present invention.

Referring to FIG. 3, the apparatus 100 for detecting the locations of radio sources according to the embodiment of the present invention includes an antenna unit 110, an intersection detecting unit 120, a wave intensity measuring unit 130, and a radio source location determining unit 140.

The apparatus 100 for detecting the locations of radio sources may be an apparatus for performing the method of detecting the locations of radio sources, as described above, and the same content as that described above in association with the method of detecting the locations of radio sources will not be repeated.

The antenna unit 110 may receive radio waves transmitted from a plurality of radio sources. Particularly, the antenna unit 110 may be installed at a plurality of measuring locations, and receive radio waves transmitted in different directions.

The intersection detecting unit 120 may measure direction angles indicating the directions of the radio sources based on a plurality of measuring locations, and detect intersections of lines extending in the directions made by the direction angles from the measuring locations.

The wave intensity measuring unit 130 may receive radio waves transmitted from the radio sources at the measuring locations, and measure the signal intensities of the radio waves. That is, the signal intensities of radio waves may be measured for the respective direction angles indicating the directions of the radio sources. Accordingly, the signal intensity of a radio wave may represent the signal intensity of a radio wave transmitted from one of intersections of lines extending in the directions made by the direction angles from the plurality of measuring locations.

The radio source location determining unit 140 may measure the distances between the measuring locations and the intersections, and reflect wave attenuation based on the distances to the signal intensities of the radio waves measured by the wave intensity measuring unit 130, thereby calculating estimated signal intensities of the radio waves. That is, the radio source location determining unit 140 may calculate an estimated signal intensity of a radio wave for each intersection at each measuring location, and determine whether the estimated signal intensities of the radio waves at the different measuring locations are identical to each other, thereby detecting the real locations of the radio sources.

For example, if the estimated signal intensities of a radio wave for the same intersection, estimated at the different measuring locations, are identical to each other, the radio source location determining unit 140 may determine that the corresponding intersection is the real location of a radio source. On the other hand, if the estimated signal intensities of a radio wave for the same intersection, estimated at the different measuring locations, are not identical to each other, the radio source location determining unit 140 may determine that the corresponding intersection is not the real location of a radio source.

In FIG. 3, the antenna unit 110, the intersection detecting unit 120, the wave intensity measuring unit 130, and the radio source location determining unit 140 are shown as separate units, however, it is also possible to integrate the antenna unit 110, the intersection detecting unit 120, the wave intensity measuring unit 130, and the radio source location determining unit 140 into a single unit, that is, a single physical apparatus. Also, each of the antenna unit 110, the intersection detecting unit 120, the wave intensity measuring unit 130, and the radio source location determining unit 140 may be configured as a physical apparatus, a plurality of physical apparatuses that cannot be grouped, or a group.

As described above, a method and apparatus for detecting the transmission locations of radio waves based on the transmission directions and signal intensities of the radio waves when the radio waves are transmitted from a plurality of radio sources are provided.

The method and apparatus for detecting the transmission locations of radio waves may be applied to a technology for detecting a location at which jamming has occurred, etc.

While the example embodiments of the present invention and their advantages have been described in detail, it should be understood that various changes, substitutions and alterations may be made herein without departing from the scope of the invention.

What is claimed is:

1. A method of detecting the location of a radio source, comprising:
calculating a plurality of direction angles indicating directions of a plurality of radio sources based on a plurality of measuring locations, and detecting a plurality of intersections of lines extending in directions made by the direction angles from the plurality of measuring locations; and
selecting real locations of the radio sources from among the intersections using signal intensities of radio waves transmitted from the plurality of radio sources and wave attenuation based on distances from the plurality of measuring locations to the intersections.

2. The method of claim 1, wherein the selecting of the real locations of the radio sources comprises:
measuring the signal intensities of the radio waves transmitted from the plurality of radio sources at the plurality of measuring locations;
measuring the distances between the plurality of measuring locations and the intersections, and reflecting the wave attenuation based on the distances in the signal intensities of the radio waves, to thereby calculate estimated signal intensities of the radio waves; and
selecting the real locations of the radio sources from among the intersections based on the estimated signal intensities of the radio waves.

3. The method of claim 2, wherein the calculating of the estimated signal intensities of the radio waves comprises calculating an estimated signal intensity of a radio wave for each intersection at each measuring location.

4. The method of claim 3, wherein the selecting of the real locations of the radio sources comprises determining intersections for which the estimated signal intensities of the radio waves, estimated at the plurality of measuring locations, are identical to each other, as the real locations of the radio sources.

5. An apparatus for detecting the location of a radio source, comprising:
an intersection detecting unit configured to calculate a plurality of direction angles indicating the directions of a plurality of radio sources based on a plurality of measuring locations, and to detect a plurality of intersections using the plurality of direction angles;
a wave intensity measuring unit configured to measure signal intensities of radio waves transmitted from the plurality of radio sources at the plurality of measuring locations; and
a radio source location determining unit configured to measure distances between the plurality of measuring locations and the intersections, and to select real locations of the radio sources from among the intersections using estimated signal intensities of the radio waves obtained by reflecting wave attenuation based on the distances in the signal intensities of the radio waves.

6. The apparatus of claim 5, wherein the intersection detection unit detects points at which lines extending in directions made by the direction angles from the plurality of measuring locations intersect with each other as the intersections.

7. The apparatus of claim 5, wherein the radio source location determining unit calculates an estimated signal intensity of a radio wave for each intersection at each measuring location.

8. The apparatus of claim 7, wherein the radio source location determining unit determines intersections for which the estimated signal intensities of radio waves, estimated at the plurality of measuring locations, are identical to each other as the real locations of the radio sources.
